(19) United States
(12) Patent Application Publication
(10) Pub. No.: US 2025/0289317 A1
(43) Pub. Date: Sep. 18, 2025

(54) ELECTRIFIED VEHICLE

(71) Applicant: TOYOTA JIDOSHA KABUSHIKI KAISHA, Toyota-shi (JP)

(72) Inventor: Mitsumasa FUKUMURA, Nagoya-shi (JP)

(73) Assignee: TOYOTA JIDOSHA KABUSHIKI KAISHA, Toyota-shi (JP)

(21) Appl. No.: 19/014,704

(22) Filed: Jan. 9, 2025

(30) Foreign Application Priority Data
Mar. 18, 2024 (JP) 2024-041817

(51) Int. Cl. B60L 15/20; B60K 1/02; B60K 11/02

(52) U.S. Cl. CPC B60L 15/20; B60K 1/02; B60K 11/02; B60L 2240/425

(57) ABSTRACT

An electrified vehicle includes: a first drive device including a first motor that is a sub-drive motor; a first drive circuit for driving the first motor; a first cooling device for cooling the first drive device; a second drive device including a second motor that is a main drive motor; a second drive circuit for driving the second motor; a second cooling device for cooling the second drive device; a third cooling device for circulating a heat exchange medium through the first drive circuit, the second drive circuit, the second cooling device, and the first cooling device in this order; and a control device configured to adjust the amount of circulation of a first heat exchange medium based on a first margin temperature and a third margin temperature.

### CROSS-REFERENCE TO RELATED APPLICATION

This application claims priority to Japanese Patent Application No. 2024-041817 filed on Mar. 18, 2024. The disclosure of the above-identified application, including the specification, drawings, and claims, is incorporated by reference herein in its entirety.

### BACKGROUND

### 1. Technical Field

The present disclosure relates to electrified vehicles. More specifically, the present disclosure relates to an electrified vehicle equipped with two motors, two inverters configured to drive the two motors, and a cooling device configured to cool the two motors and the two inverters.

### 2. Description of Related Art

Conventionally, an electrified vehicle including a motor, an oil cooler for cooling the motor, an inverter for driving the motor, and a cooling device for cooling the oil cooler and the inverter has been proposed as this type of electrified vehicle (see, for example, Japanese Unexamined Patent Application Publication No. 2019-129632 (JP 2019-129632 A)). The cooling device of this vehicle causes a heat exchange medium cooled by a radiator to flow through the inverter and the oil cooler in this order, and performs control to start, increase, reduce, or stop oil circulation through the oil cooler based on the temperature of the inverter or the temperature of the heat exchange medium.

### SUMMARY

In an electrified vehicle including a rear wheel drive motor serving as a main drive motor and a front wheel drive motor serving as a sub-drive motor, an oil cooler for cooling the rear wheel drive motor and an inverter for driving this motor are disposed near the rear wheel drive motor, and an oil cooler for cooling the front wheel drive motor and an inverter for driving this motor are disposed near the front wheel drive motor. When cooling these components, a heat exchange medium cooled by a radiator is circulated through the inverter for driving the front wheel drive motor, the inverter for driving the rear wheel drive motor, the oil cooler for cooling the rear wheel drive motor, and the oil cooler for driving the front wheel drive motor in this order. In this case, depending on adjustment of the amount of oil circulation through the oil cooler for cooling the front wheel drive motor, the rear wheel drive motor serving as the main drive motor may limit its output torque before the front wheel drive motor serving as the sub-drive motor due to overheating of the inverter for driving the rear wheel drive motor and the oil cooler for cooling the rear wheel drive motor, which may lead to poor drive feel.

An object of an electrified vehicle of the present disclosure is to reduce the possibility that driving of a main drive motor may be limited before a sub-drive motor.

An electrified vehicle of the present disclosure adopts the following measures in order to achieve the above object.

The electrified vehicle of the present disclosure is an electrified vehicle including:
a first drive device including a first motor that is a sub-drive motor;
a first drive circuit configured to drive the first motor;
a first cooling device configured to cool the first drive device with a first heat exchange medium;
a second drive device including a second motor that is a main drive motor;
a second drive circuit configured to drive the second motor;
a second cooling device configured to cool the second drive device with a second heat exchange medium;
a third cooling device configured to circulate a third heat exchange medium through the first drive circuit, the second drive circuit, the second cooling device, and the first cooling device in this order; and
a control device configured to control the first cooling device, the second cooling device, the third cooling device, the first motor, and the second motor.

The control device is configured to adjust an amount of circulation of the first heat exchange medium based on a first margin temperature and a third margin temperature. The first margin temperature is a difference between a temperature of the first heat exchange medium and a first predetermined temperature. The third margin temperature is a difference between a temperature of the third heat exchange medium in the first cooling device and a third predetermined temperature.

In the electrified vehicle of the present disclosure, the third cooling device is configured to circulate the third heat exchange medium in the following order: the first drive circuit configured to drive the first motor that is the sub-drive motor, the second drive circuit configured to drive the second motor that is the main drive motor, the second cooling device configured to cool the second drive device including the second motor with the second heat exchange medium, and the first cooling device configured to cool the first drive device including the first motor with the first heat exchange medium. The control device is configured to adjust the amount of circulation of the first heat exchange medium based on the first margin temperature and the third margin temperature. The first margin temperature is the difference between the temperature of the first heat exchange medium and the first predetermined temperature. The third margin temperature is the difference between the temperature of the third heat exchange medium in the first cooling device and the third predetermined temperature. It is possible to limit driving of the first motor serving as the sub-drive motor before the second motor serving as the main drive motor by more appropriately adjusting the first predetermined temperature and the first heat exchange medium. Driving of the second motor serving as the main drive motor is less likely to be limited before the first motor serving as the sub-drive motor. Each of the first predetermined temperature and the third predetermined temperature can be a lower limit temperature for limiting driving of the first motor.

In the electrified vehicle of the present disclosure,
the control device may be configured to control the amount of circulation of the first heat exchange medium in such a manner that the amount of circulation of the first heat exchange medium increases as the first margin temperature decreases and that the amount of circulation of the first heat exchange medium increases as the third margin temperature decreases.

This is based on the fact that the smaller the first margin temperature, the higher the need to cool the first motor, and the smaller the third margin temperature, the higher the need to cool the first motor.

In the electrified vehicle of the present disclosure,
the control device may be configured to limit driving of the first motor when the temperature of the first heat exchange medium is equal to or higher than the first predetermined temperature or when the temperature of the third heat exchange medium is equal to or higher than the third predetermined temperature.

Limiting driving of the first motor serving as the sub-drive motor in this manner makes it possible to delay limiting driving of the second motor serving as the main drive motor. In this case, the control device may be configured to cut off a driving force of the first drive device when the temperature of the first heat exchange medium is equal to or higher than a first specific temperature that is higher than the first predetermined temperature or when the temperature of the third heat exchange medium in the first cooling device is equal to or higher than a third specific temperature that is higher than the third predetermined temperature.

This makes it possible to delay limiting driving of the second motor serving as the main drive motor or to limit driving of the second motor serving as the main drive motor to a smaller extent.

In the electrified vehicle of the present disclosure,
the control device may be configured to adjust an amount of circulation of the second heat exchange medium based on a second margin temperature and a fourth margin temperature. The second margin temperature may be a difference between a temperature of the second heat exchange medium and a second predetermined temperature, and the fourth margin temperature may be a difference between the temperature of the third heat exchange medium in the second cooling device and a fourth predetermined temperature.

It is therefore possible to more appropriately limit driving of the second motor serving as the main drive motor.

In this case, the control device may be configured to adjust the amount of circulation of the second heat exchange medium in such a manner that the amount of circulation of the second heat exchange medium increases as the second margin temperature decreases and that the amount of circulation of the second heat exchange medium increases as the third margin temperature decreases.

This is based on the fact that the smaller the second margin temperature, the higher the need to cool the second motor, and the smaller the fourth margin temperature, the higher the need to cool the second motor.

The control device may be configured to limit driving of the second motor when the temperature of the second heat exchange medium is equal to or higher than the second predetermined temperature.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a configuration diagram schematically illustrating a configuration of an electrified vehicle according to an embodiment of the present disclosure;

FIG. 2 is a flowchart illustrating an example of a first oil pump process performed by the electronic control unit 70;

FIG. 3 is a flowchart illustrating an example of a second oil pump process performed by the electronic control unit 70;

FIG. 4 is a flowchart illustrating an example of a motor limiting process executed by the electronic control unit 70;

FIG. 5 is an explanatory diagram illustrating an exemplary drive duty cycle setting map; and

FIG. 6 is an explanatory diagram illustrating an exemplary relationship between the first oil temperature To1, the first coolant temperature Tw1 and limitation of the driving force of the first motor 31, and a relationship between the second oil temperature To2, the second coolant temperature Tw2, and limitation of the driving force of the second motor 41.

### DETAILED DESCRIPTION OF EMBODIMENTS

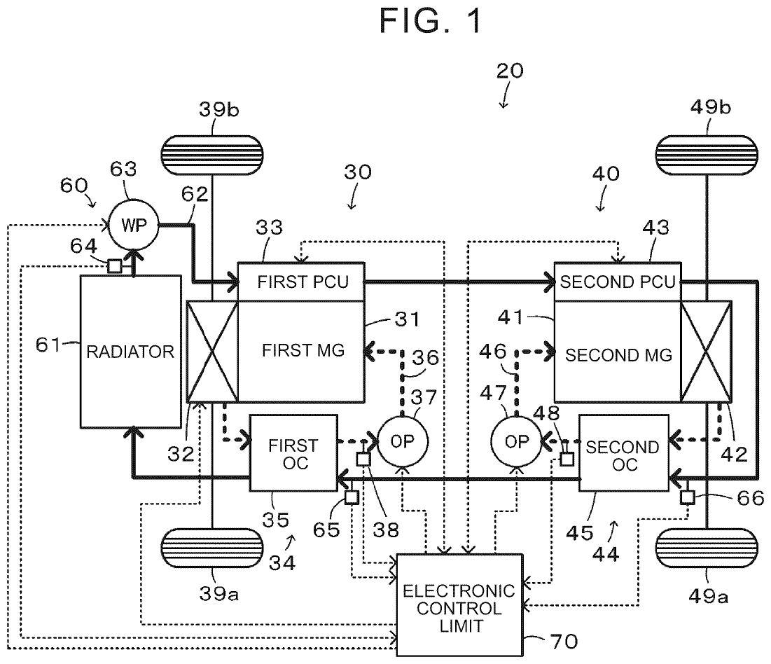

Next, a mode (embodiment) for carrying out the present disclosure will be described. FIG. 1 is a configuration diagram schematically illustrating a configuration of an electrified vehicle 20 according to an embodiment of the present disclosure. Electrified vehicle 20 of the embodiment includes a first drive device 30 that is a sub-drive device for driving the front wheels, a first power control unit (hereinafter referred to as first PCU) 33 that drives the first drive device 30, a first cooling device 34 that cools the first drive device 30, a second drive device 40 that is a main drive device for driving the rear wheels, a second power control unit (hereinafter referred to as second PCU) 43 that drives the second drive device 40, a second cooling device 43 that cools the second drive device 40, a third cooling device 60, and an electronic control unit 70.

The first drive device 30 is disposed at a front portion of the vehicle, and includes a first motor 31 and a first gear unit 32. The first motor 31 is configured as, for example, a synchronous generator motor or the like, and is connected to the first gear unit 32. The first gear unit 32 is configured as a gear mechanism such as a reduction gear and a differential gear, and is connected to the front wheels 39a, 39b. The first gear unit 32 includes a clutch (not shown) on the front wheels 39a, 39b, and the first motor 31 and the first gear unit 32 can be separated from the front wheels 39a, 39b.

The first PCU 33 is configured as a drive circuit for converting the power from the battery (not shown) to the three-phase AC by boosting and applying it to the first motor 31, for example, it is constituted by a well-known boosting circuit and well-known inverters. The first PCU 33 is disposed around the first drive device 30.

The first cooling device 34 is disposed adjacent to the first drive device 30, and includes a first oil cooler 35 that supplies the cooled oil to the first motor 31 and the first gear unit 32 through the circulation flow path 36. A first temperature sensor 38 for detecting the temperature (first oil temperature) To1 of the oil and a first oil pump 37 for adjusting the circulation quantity of the oil are attached to the vicinity of the outlet of the first oil cooler 35 of the circulation flow path 36. The cooling oil also functions as a lubricating oil.

The second drive device 40 is disposed at the rear of the vehicle, and includes a second motor 41 and a second gear unit 42. The second motor 41 is configured as, for example, a synchronous generator motor or the like, and is connected to the second gear unit 42. The second gear unit 42 is configured as a gear mechanism such as a reduction gear and a differential gear, and is connected to the rear wheels 49a, 49b.

The second PCU 43 is configured as a drive circuit for applying to the second motor 41 by converting the power from the battery (not shown) to the three-phase AC by boosting, for example, it is constituted by a well-known boosting circuit and well-known inverters. The second PCU 43 is disposed around the second drive device 40.

The second cooling device 44 is disposed adjacent to the second drive device 40, and includes a second oil cooler 45 that supplies the cooled oil to the second motor 41 and the second gear unit 42 through the circulation flow path 46. A second temperature sensor 48 for detecting the temperature (second oil temperature) To2 of the oil and a second oil pump 47 for adjusting the circulation quantity of the oil are attached to the vicinity of the outlet of the second oil cooler 45 of the circulation flow path 46. The cooling oil also functions as a lubricating oil.

The third cooling device 60 includes a radiator 61 disposed at a front portion of the vehicle, a circulation flow path 62, and a water pump 63 that circulates coolant. The coolant flows from the radiator 61 to the water pump 63, a cooling flow passage formed in the first PCU 33, a cooling flow passage formed in the second PCU 43, a cooling flow passage formed in the second oil cooler 45, a cooling flow passage formed in the first oil cooler 35, and flows in the order of the radiator 61, and cools down the booster circuit and the inverter of the first PCU 33, the booster circuit and the inverter of the second PCU 43, the oil of the second oil cooler 45, and the oil of the first oil cooler 35 in this order. Temperature sensors 64, 65, and 66 are attached in the vicinity of the outlet of the radiator 61 of the circulation flow path 62, in the vicinity of the outlet of the first oil cooler 35, and in the vicinity of the inlet of the second oil cooler 45.

The electronic control unit 70 is constituted by a microcomputer centered on a CPU (not shown). The electronic control unit 70 receives the first oil temperature To1 from the first temperature sensor 38, the second oil temperature To2 from the second temperature sensor 48, the coolant temperature Tw0, the first coolant temperature Tw1, the second coolant temperature Tw2 from the temperature sensors 64, 65, 66, and the like. The electronic control unit 70 outputs a drive control signal to the first oil pump 37, a drive control signal to the second oil pump, a drive control signal to the water pump 63, and the like. The electronic control unit 70 also controls the driving of electrified vehicle 20. For this reason, the electronic control unit 70 also receives the shift position SP, the accelerator operation amount Acc, the brake pedal position BP, the three-phase currents I1u, I1v, and I1w applied to the first motor 31, the three-phase currents I2u, I2v, and I2w applied to the second motor 41, and the like, and the electronic control unit 70 outputs a switching control signal for switching the boosting circuit of the first PCU 33 and the switching element of the inverter, a switching control signal for switching the boosting circuit of the second PCU 43 and the switching element of the inverter, and the like.

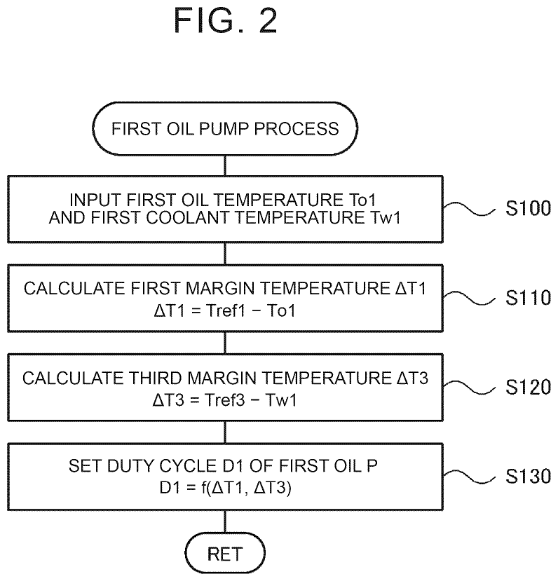

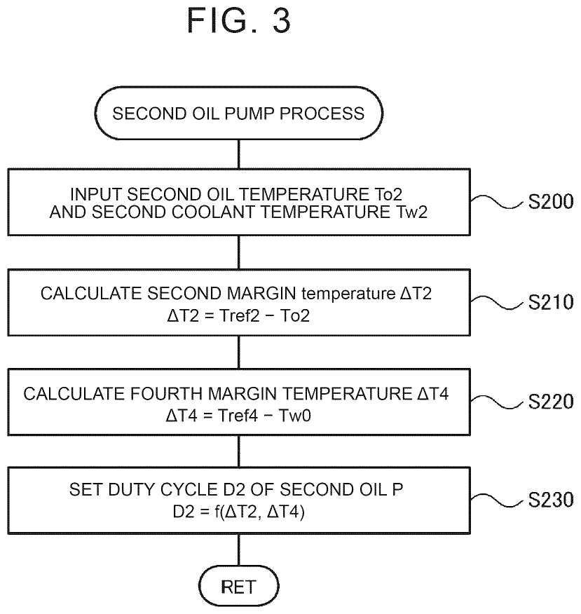

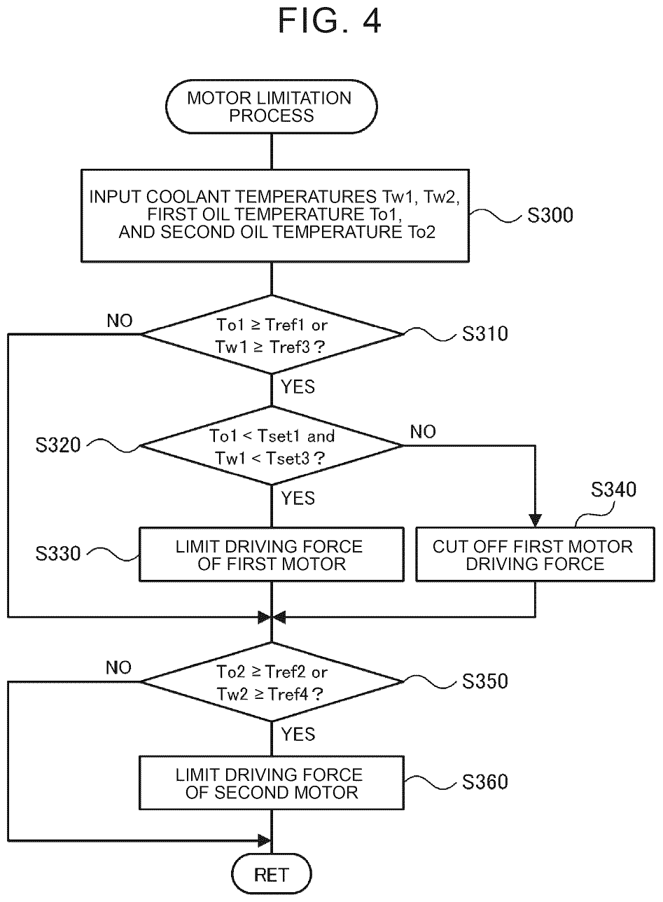

Next, an operation of electrified vehicle 20 configured as described above, in particular, an operation of the first oil pump 37 and the second oil pump 47, and an operation when limiting the driving force of the first drive device 30 or the second drive device 40 will be described. FIG. 2 is a flow chart illustrating an exemplary first oil pump process performed by the electronic control unit 70 to set the drive duty cycle D1 of the first oil pump 37. FIG. 3 is a flow chart illustrating an exemplary second oil pump process performed by the electronic control unit 70 to set the drive duty cycle D2 of the second oil pump 47. FIG. 4 is a flowchart illustrating an example of a motor limiting process executed by the electronic control unit 70. Hereinafter, the routines will be described in order.

When the first oil pump process of FIG. 2 is executed, the electronic control unit 70 first executes a process of inputting data required to set the drive duty cycle D1 of the first oil pump 37, such as the first oil temperature To1 from the first temperature sensor 38 and the first coolant temperature Tw1 from the temperature sensor 65 (S100). Subsequently, the first margin temperature ΔT1 is calculated by subtracting the first oil temperature To1 from the first predetermined value Tref1 (S110), and the third margin temperature ΔT3 is calculated by subtracting the first coolant temperature Tw1 from the third predetermined value Tref3 (S120). The first predetermined value Tref1 is set as the lower limit temperature of the oil near the outlet of the first oil cooler 35 at which the driving force of the first drive device 30 is limited. The third predetermined value Tref3 is set as the lower limit temperature of the coolant in the vicinity of the inlet of the first oil cooler 35 at which the driving force of the first drive device 30 is limited.

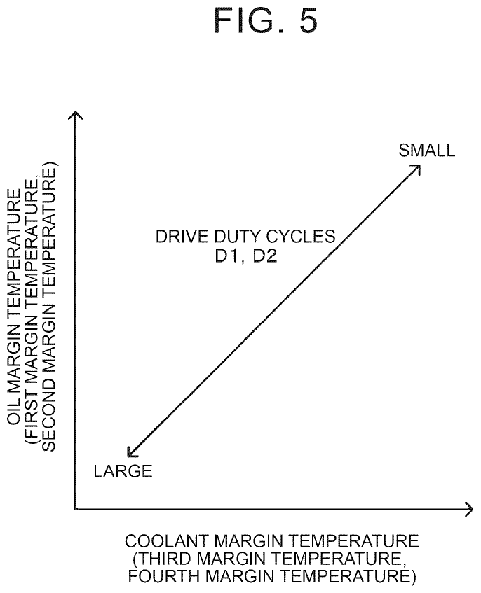

Next, the drive duty cycle D1 of the first oil pump 37 is set based on the first margin temperature ΔT1 and the third margin temperature ΔT3 (S130), and the process ends. In the present embodiment, the drive duty cycle D1 is set by previously determining the relation between the first margin temperature ΔT1, the third margin temperature ΔT3, and the drive duty cycle D1 by experimentation, machine learning, or the like, storing the relation as a drive duty cycle setting map, and deriving the corresponding drive duty cycle D1 from the map when the first margin temperature ΔT1 and the third margin temperature ΔT3 are given. FIG. 5 shows an example of the drive duty cycle setting map. As shown in the drawing, the drive duty cycle D1 is set so as to increase as the first margin temperature ΔT1 decreases and to increase as the third margin temperature ΔT3 decreases. This is based on the fact that the degree of cooling of the first drive device 30 increases as the first margin temperature ΔT1 decreases and increases as the third margin temperature ΔT3 decreases.

When the second oil pump process of FIG. 3 is executed, the electronic control unit 70 first executes a process of inputting data required for setting the drive duty cycle D2 of the second oil pump 47, such as the second oil temperature To2 from the second temperature sensor 48 and the second coolant temperature Tw2 from the temperature sensor 66 (S200). Subsequently, the second margin temperature ΔT2 is calculated by subtracting the second oil temperature To2 from the second predetermined value Tref2 (S210), and the fourth margin temperature ΔT4 is calculated by subtracting the second coolant temperature Tw2 from the fourth predetermined value Tref4 (S220). The second predetermined value Tref2 is set as the lower limit temperature of the oil in the vicinity of the outlet of the second oil cooler 45 at which the driving force of the second drive device 40 is limited. The fourth predetermined value Tref4 is set as the lower limit temperature of the coolant in the vicinity of the inlet of the second oil cooler 45 at which the driving force of the second drive device 40 is limited.

Next, the drive duty cycle D2 of the second oil pump 47 is set based on the second margin temperature ΔT2 and the fourth margin temperature ΔT4 (S330), and the process ends. In the present embodiment, the drive duty cycle D2 is set by previously determining the relation between the second margin temperature ΔT2, the fourth margin temperature ΔT4, and the drive duty cycle D2 by experimentation, machine learning, or the like, storing the relation as a drive duty cycle setting map, and deriving the corresponding drive duty cycle D2 from the map when the second margin temperature ΔT2 and the fourth margin temperature ΔT4 are given. The drive duty cycle D2 of the second oil pump 47 can also be obtained by the drive duty cycle setting map illustrated in FIG. 5. As shown in the drawing, the drive duty cycle D2 is set to be larger as the second margin temperature ΔT2 is smaller and to be larger as the fourth margin temperature ΔT4 is smaller. This is based on the fact that the degree of cooling of the second drive device 40 increases as the second margin temperature ΔT2 decreases and increases as the fourth margin temperature ΔT4 decreases.

When the motor limiting process of FIG. 4 is executed, the electronic control unit 70 first performs a process of inputting the first coolant temperature Tw1 from the temperature sensor 65, the second coolant temperature Tw2 from the temperature sensor 66, the first oil temperature To1 from the first temperature sensor 38, and the second oil temperature To2 from the second temperature sensor 48, which are required to limit the driving force of the first motor 31 and the driving force of the second motor 41 (S300).

Next, it is determined whether or not the first oil temperature To1 is equal to or greater than the first predetermined value Tref1 or the first coolant temperature Tw1 is equal to or greater than the third predetermined value Tref3 (S310), and it is determined whether or not the first oil temperature To1 is less than the first specific value Tset1 or whether or not the first coolant temperature Tw1 is less than the third specific value Tset3 (S320). Here, the first specific value Tset1 is set as the lower limit temperature of the oil in the vicinity of the outlet of the first oil cooler 35 at which the driving force of the first drive device 30 is cut off (driving force is value 0), and is a value larger than the first predetermined value Tref1. The third specific value Tset3 is set as the lower limit temperature of the coolant in the vicinity of the inlet of the first oil cooler 35 at which the driving force of the first drive device 30 is cut off, and is a value larger than the third predetermined value Tref3.

When it is determined in S310,S320 that the first coolant temperature Tw1 is less than the third specific value Tset3 and the first oil temperature To1 is greater than or equal to the first predetermined value Tref and less than the first specific value Tset1, and when it is determined that the first oil temperature To1 is less than the first specific value Tset1 and the first coolant temperature Tw1 is greater than or equal to the third predetermined value Tref3 and less than the third specific value Tset3, the driving force of the first motor 31 is limited (the first drive device 30) (S330). It is preferable that the driving force is more limited as the first oil temperature To1 increases, and the driving force is more limited as the first coolant temperature Tw1 increases.

When it is determined in S320 that the first oil temperature To1 is equal to or higher than the first specific value Tset1, or when it is determined that the first coolant temperature Tw1 is equal to or higher than the third specific value Tset3, the driving force of the first motor 31 (first drive device 30) is cut off (S340). The driving force can be cut off by disconnecting the first drive device 30 from the front wheels 39a, 39b by turning off a clutch (not shown) of the first gear unit 32.

When the first oil temperature To1 is less than the first predetermined value Tref1 and the first coolant temperature Tw1 is less than the first predetermined value Tref1, the driving force of the first motor 31 is not limited.

Next, it is determined whether the second oil temperature To2 is equal to or higher than the second predetermined value Tref2 or whether the second coolant temperature Tw2 is equal to or higher than the fourth predetermined value Tref4 (S350). When it is determined that the second oil temperature To2 is equal to or higher than the second predetermined value Tref2 or when it is determined that the second coolant temperature Tw2 is equal to or higher than the fourth predetermined value Tref4, a driving force of the second motor 41 (second drive device 40) is limited (S360), and the process ends. When it is determined that the second oil temperature To2 is less than the second predetermined value Tref2 and the second coolant temperature Tw2 is less than the fourth predetermined value Tref4, the driving force of the second motor 41 (second drive device 40) is not limited.

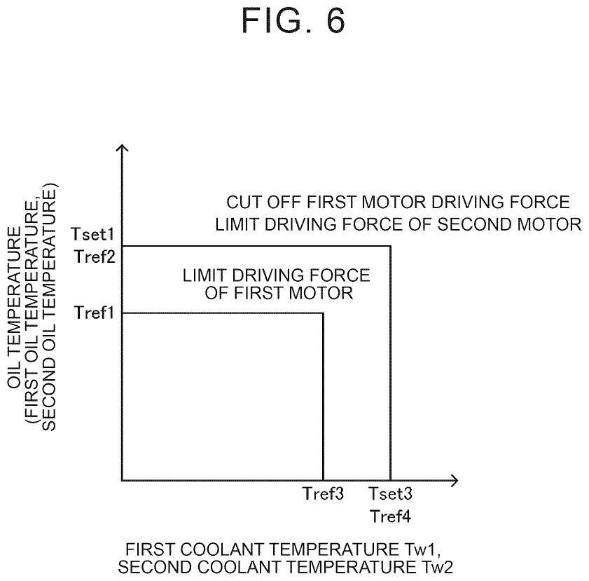

FIG. 6 illustrates an exemplary relationship between the first oil temperature To1, the first coolant temperature Tw1, and limitation of the driving force of the first motor 31, and a relationship between the second oil temperature To2, the second coolant temperature Tw2, and limitation of the driving force of the second motor 41. In the embodiment of FIG. 6, the first specific value Tset1 and the third specific value Tset3 used when cutting off the driving force of the first motor 31 and the second predetermined value Tref2 and the fourth predetermined value Tref4 used when limiting the driving force of the second motor 41 are set to the same value. In the first motor 31, the driving force is limited in the region from the first predetermined value Tref1 to the first specific value Tset1 and in the region from the third predetermined value Tref3 to the third specific value Tset3, and the driving force is cut off in the region of the first specific value Tset1 or more and in the region of the third specific value Tset3 or more. The driving force of the second motor 41 is limited in a region where the driving force of the first motor 31 is cut off.

In electrified vehicle 20 of the embodiment described above, the coolant flows in the order of the first PCU 33 for driving the first drive device 30 that is a sub-drive device for driving the front wheels, the second PCU 43 for driving the second drive device 40 that is a main drive device for driving the rear wheels, the second oil cooler 45 of the second cooling device 44 for cooling the second drive device 40, and the first oil cooler 35 of the first cooling device 34 for cooling the first drive device 30. Then, the drive duty cycle DI of the first oil pump 37 is set so as to increase as the first margin temperature ΔT1 decreases and so as to increase as the third margin temperature ΔT3 decreases. Further, the drive duty cycle D2 of the second oil pump 47 is set so as to be larger as the second margin temperature ΔT2 is smaller and so as to be larger as the fourth margin temperature ΔT4 is smaller. By appropriately setting the predetermined values Tref1 to Tref4, the specific values Tset1, Tset3, the driving force of the first motor 31 serving as a sub-drive motor can be limited before the second motor 41 serving as a main drive motor. As a result, the drive force of the second motor 41 serving as a main drive motor is less likely to be limited before the first motor 31 serving as the sub-drive motor.

In electrified vehicle 20 of the embodiment, in the explanation of FIG. 6, the first specific value Tset1 and the third specific value Tset3 used when cutting off the driving force of the first motor 31 and the second predetermined value Tref2 and the fourth predetermined value Tref4 used when limiting the driving force of the second motor 41 are set to the same value. However, the second predetermined value Tref2 and the fourth predetermined value Tref4 used when limiting the driving force of the second motor 41 may be different from the first specific value Tset1 and the third specific value Tset3 used for cutting off the driving force of the first motor 31. In this case, in order to limit the driving force of the second motor 41 serving as the main drive motor before the first motor 31 serving as the sub-drive motor, the second predetermined value Tref2 may be a value larger than the first predetermined value Tref1, and the fourth predetermined value Tref4 may be a value larger than the third predetermined value Treef3.

In electrified vehicle 20 of the embodiment, the temperature near the outlet of the first oil cooler 35 (the first oil temperature To1) is used as the oil temperature of the first cooling device 34, but the temperature near the inlet of the first oil cooler 35 may be used. Similarly, the temperature in the vicinity of the inlet of the second oil cooler 45 may be used as the oil temperature of the second cooling device 44.

The correspondence between the main elements of the embodiments and the main elements of the disclosure described in the column of the means for solving the problem will be described. In the embodiment, the first motor 31 corresponds to the “first motor”, the first drive device 30 corresponds to the “first drive device”, the first PCU 33 corresponds to the “first drive circuit”, the first cooling device 34 corresponds to the “first cooling device”, the second motor 41 corresponds to the “second motor”, the second drive device 40 corresponds to the “second drive device”, the second PCU 43 corresponds to the “second drive circuit”, the second cooling device 44 corresponds to the “second cooling device”, the third cooling device 60 corresponds to the “third cooling device”, and the electronic control unit 70 corresponds to the “control device”.

Note that the correspondence between the main elements of the embodiment and the main elements of the disclosure described in the section of the means for solving the problem is an example for specifically explaining the embodiment of the disclosure described in the section of the means for solving the problem, and therefore the elements of the disclosure described in the section of the means for solving the problem are not limited. That is, the interpretation of the disclosure described in the section of the means for solving the problem should be performed based on the description in the section, and the embodiments are only specific examples of the disclosure described in the section of the means for solving the problem.

Although the present disclosure has been described above using the embodiment, the present disclosure is not limited to the embodiment in any way, and may be implemented in various modes without departing from the scope of the present disclosure.

The present disclosure is applicable to a manufacturing industry of an electrified vehicle 20 and the like.

What is claimed is:

1. An electrified vehicle comprising:
a first drive device including a first motor that is a sub-drive motor;
a first drive circuit configured to drive the first motor;
a first cooling device configured to cool the first drive device with a first heat exchange medium;
a second drive device including a second motor that is a main drive motor;
a second drive circuit configured to drive the second motor;
a second cooling device configured to cool the second drive device with a second heat exchange medium;
a third cooling device configured to circulate a third heat exchange medium through the first drive circuit, the second drive circuit, the second cooling device, and the first cooling device in this order; and
a control device configured to control the first cooling device, the second cooling device, the third cooling device, the first motor, and the second motor, wherein the control device is configured to adjust an amount of circulation of the first heat exchange medium based on a first margin temperature and a third margin temperature, the first margin temperature being a difference between a temperature of the first heat exchange medium and a first predetermined temperature, and the third margin temperature being a difference between a temperature of the third heat exchange medium in the first cooling device and a third predetermined temperature.

2. The electrified vehicle according to claim 1, wherein the control device is configured to control the amount of circulation of the first heat exchange medium in such a manner that the amount of circulation of the first heat exchange medium increases as the first margin temperature decreases and that the amount of circulation of the first heat exchange medium increases as the third margin temperature decreases.

3. The electrified vehicle according to claim 1, wherein the control device is configured to limit driving of the first motor when the temperature of the first heat exchange medium is equal to or higher than the first predetermined temperature or when the temperature of the third heat exchange medium is equal to or higher than the third predetermined temperature.

4. The electrified vehicle according to claim 3, wherein the control device is configured to cut off a driving force of the first drive device when the temperature of the first heat exchange medium is equal to or higher than a first specific temperature that is higher than the first predetermined temperature or when the temperature of the third heat exchange medium in the first cooling device is equal to or higher than a third specific temperature that is higher than the third predetermined temperature.

5. The electrified vehicle according to claim 1, wherein the control device is configured to adjust an amount of circulation of the second heat exchange medium based on a second margin temperature and a fourth margin temperature, the second margin temperature being a difference between a temperature of the second heat exchange medium and a second predetermined temperature, and the fourth margin temperature being a difference between the temperature of the third heat exchange medium in the second cooling device and a fourth predetermined temperature.

6. The electrified vehicle according to claim 5, wherein the control device is configured to adjust the amount of circulation of the second heat exchange medium in such a manner that the amount of circulation of the second heat exchange medium increases as the second margin temperature decreases and that the amount of circulation of the second heat exchange medium increases as the third margin temperature decreases.

7. The electrified vehicle according to claim 5, wherein the control device is configured to limit driving of the second motor when the temperature of the second heat exchange medium is equal to or higher than the second predetermined temperature.
